(19) United States
(12) Patent Application Publication
(10) Pub. No.: US 2011/0079620 A1
(43) Pub. Date: Apr. 7, 2011

(54) KIT FOR MODULAR STRUCTURES ON A VEHICLE

(75) Inventor: Petar TODOROVIC, Toronto (CA)

(73) Assignee: APPOLO MACHINE LTD., Mississuga (CA)

(21) Appl. No.: 12/896,388

(22) Filed: Oct. 1, 2010

Related U.S. Application Data
(60) Provisional application No. 61/248,010, filed on Oct. 2, 2009.

(51) Int. Cl. B60R 9/04; B23P 17/04

(52) U.S. Cl. 224/309; 29/428

(57) ABSTRACT

A kit, system and method for forming a modular rack for a vehicle includes a plurality of adaptor clamps for connecting an end of any one of a plurality of tube elements to a body portion of another one of the plurality of tube elements and a plurality of base clamps for connecting a portion of any one of the plurality of tube elements to a support surface on the vehicle.

### FIELD OF THE INVENTION

The present invention relates to cargo rail and rack assemblies and more particularly, to a kit and components thereof for forming modular structures including cargo rail and rack assemblies.

### BACKGROUND OF THE INVENTION

Cargo racks and rails are well known in the art, as either permanent or temporary accessories to vehicles. Prior art devices take on a number of forms, including rails mounted onto a rooftop of a vehicle, semi-permanent and permanent fixtures adapted to mount onto the rear of pick-up trucks and other such devices. Often, they are used such that cargo can safely be stored on an exterior of a vehicle in a manner that does not cause damage to exterior surfaces of the vehicle, either by having an excessive load thereon, from scratches and a lack of proper support for the cargo. Furthermore, cargo rails and racks increase the storage capacity of the vehicles.

Prior art racks and rails generally require professional or time consuming installation and take the form of fixed devices that are either not easily removable from the vehicle, or when removable, are difficult to store and remount. Furthermore a separate rack is required to store different of items, or different amounts of loads, each of which can be fairly expensive.

Often times, such racks will be custom made, by welding together a series of structural beams or tubes, in a manner similar to forming other welded, upright structures. Creating such structures is also a time consuming and difficult endeavor to the average user of such devices.

Accordingly, there is therefore a need in the art for a cargo rack and/or rail system that is one or more of, easily assembled, cost effective, user configurable and easy to store.

There is a further need in the art for a system for quickly and efficiently forming rigid structures that may be used as cargo racks, other storage structures, or any other rigid structure that may be easily assembled and disassembled.

### SUMMARY OF THE INVENTION

In accordance with one embodiment of the invention, there is provided a kit for forming a modular rack for a vehicle including a plurality of adaptor clamps for connecting an end of any one of a plurality of tube elements to a body portion of another one of the plurality of tube elements and a plurality of base clamps for connecting a portion of any one of the plurality of tube elements to a support surface on the vehicle.

According to one aspect of the invention, the plurality of tube elements are provided as part of the kit. According to an alternate aspect of the invention, the plurality of tube elements are tubes arranged to be cut to various sizes for use with the plurality of adaptor clamps and the plurality of base clamps.

According to another aspect of this embodiment, each of the plurality of adaptor clamps includes a first engaging portion for engaging an end of a first tube element and a second engaging portion for engaging a body portion of a second tube element. The first engaging portion may comprise a bore in a body portion of the adaptor clamp, sized and otherwise dimensioned to be secured to the end of said first tube element, for example in a friction fit arrangement. The second engaging portion may comprise first and second concave portions sized and dimensioned to be positioned around the body portion of the second tube element.

According to another aspect of this embodiment, the first and second concave portions are formed from a semi-rigid material and the second engaging portion further includes fastening means for securing the tube element between the first and second concave portions.

According to another aspect of the invention each of the plurality of base clamps includes a first connector for attaching to a tube element and a second connector for attaching to the support surface on the vehicle. The first connector may comprise a tube element support portion and connecting means for attachment to the second connector. The second connector may comprise a base portion for attaching to the vehicle surface and an interacting portion for engaging the connecting means of said first connector.

According to another aspect of the invention, the kit further includes a radius clamp having first and second ends adapted for engaging first and second proximate tube elements.

According to another embodiment of the invention, there is provided a system for constructing a rack on a vehicle including a plurality of adaptor clamps, a plurality of base clamps and a plurality of tubular elements, wherein the plurality of tube elements are arranged to form the rack in a construction determined by a user, by connecting tube elements with each other with one or more of said plurality of adaptor clamps and by connecting base tube elements to the vehicle using one or more of said plurality of base clamps.

According to another embodiment of the invention, there is provided a method for constructing a rack on a vehicle including providing a plurality of adaptor clamps, providing a plurality of base clamps, providing a plurality of tube elements, connecting ends of the plurality of tube elements to a body portion of another one of the plurality of tube elements using the plurality of adaptor clamps to form the rack; and connecting a portion of any one of the plurality of tube elements to a support surface on a vehicle with the plurality of base clamps.

According to another embodiment of the present invention, a kit is provided including a number of different sized tubes and the aforementioned clamp components to be joined together to form a cargo rack.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective view of an exemplary cargo rack assembled from the kit of the invention;

FIG. 2 shows various views of an exemplary adaptor clamp as provided in the kit according to an embodiment of the invention;

FIG. 3 shows various views of an exemplary second connector forming part of a base clamp as provided in the kit according to an embodiment of the invention;

FIG. 4 shows various views of an exemplary second connector forming part of a base clamp as provided in the kit according to an embodiment of the invention;

FIG. 5 shows various views of an exemplary radius clamp according to an embodiment of the present invention; and,

FIG. 6 is a detailed view of cooperating elements of the kit as shown in FIGS. 2 to 5.

FIG. 7 shows a photograph of one representative example of a rack formed with components of the kit according to one embodiment of the present invention.

### DETAILED DESCRIPTION OF THE PREFERRED EMBODIMENTS

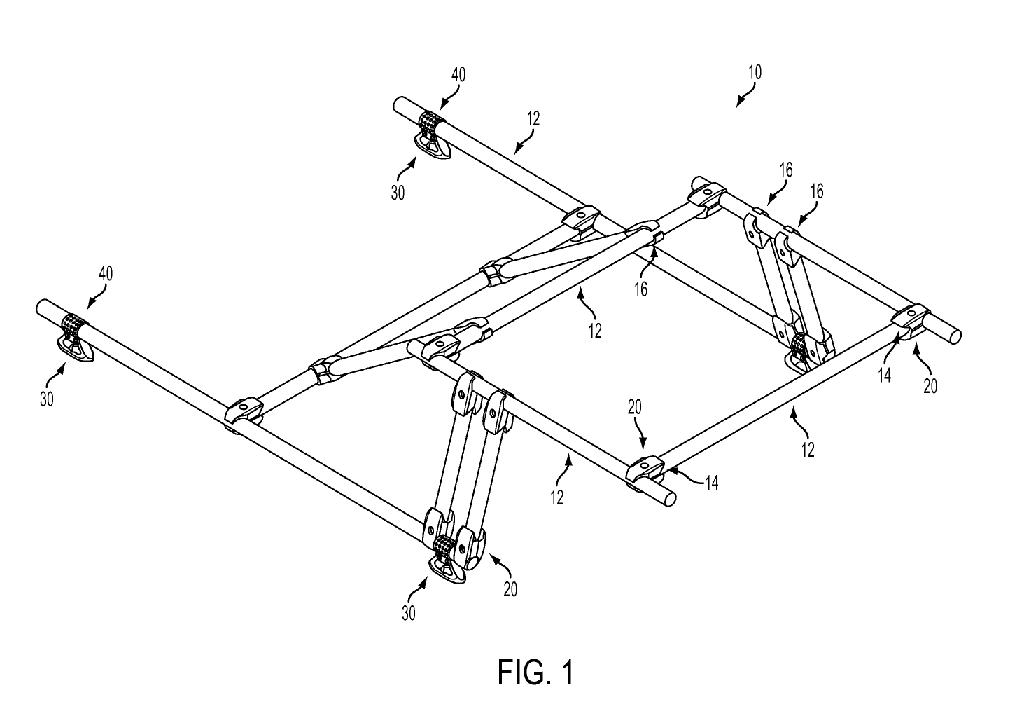

Referring now to FIG. 1, there is shown an exemplary cargo rack 10 assembled using elements of the kit according to one embodiment of the present invention. The configuration shown in FIG. 1 is one that would typically be employed on the rear of a pick-up truck, however, it will be understood by those skilled in the art that any rack assembly, or other structure, is within the abilities of one skilled in the art. The rack 10 generally comprises a number of tube elements 12 interconnected and assembled using a number of adaptor clamps 20, and a plurality of base clamps 30 as shown in FIG. 1.

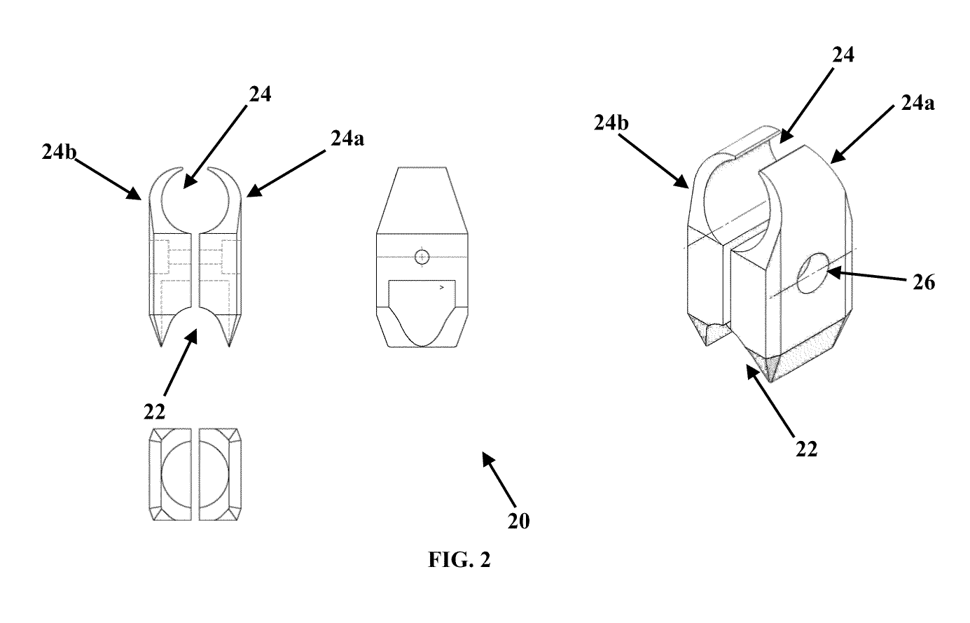

The invention relates to a kit for forming a rack, such as that shown in FIG. 1, a system comprising the elements of the kit assembled to form a rack and a method for creating a rack on a vehicle. Referring now to FIGS. 2-4, and 6, the kit generally includes a plurality of adaptor clamps 20 for connecting an end of any one of a plurality of tube elements 12a to a body portion of another one of said plurality of tube elements 12b and a plurality of base clamps 30 for connecting a portion of any one of the plurality of tube elements to a support surface on the vehicle.

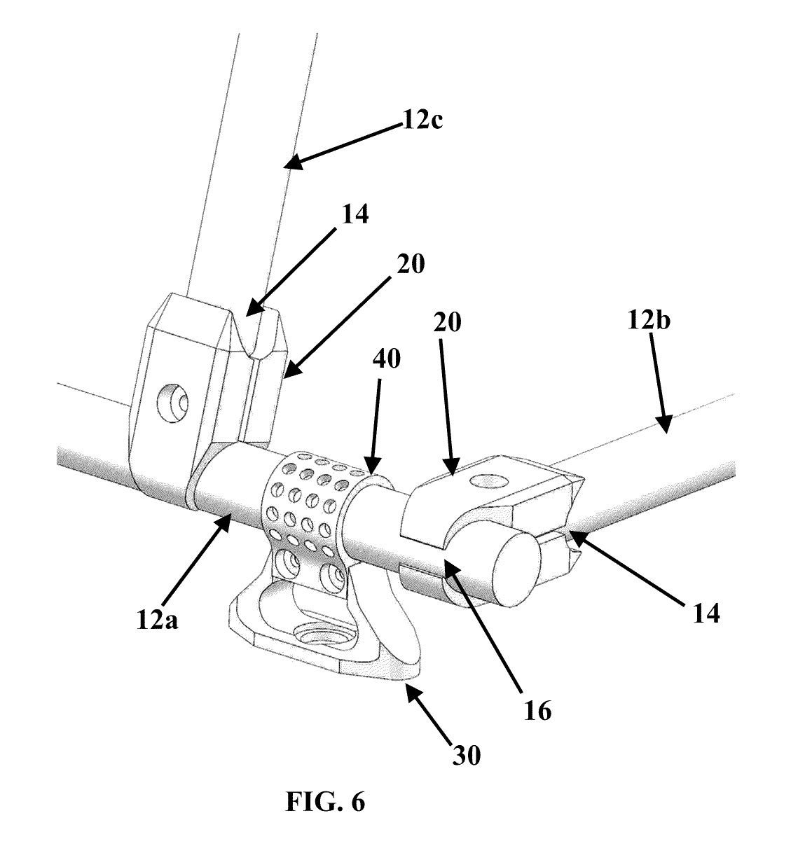

As shown in FIGS. 2 and 6, the adaptor clamp 20 includes a first engaging portion 22 adapted to engage an end 14 of a respective tube element 12b and a second engaging portion 24 adapted to engage an intermediate portion 16 of an adjacent tube element 12a. In the illustrated embodiment, the first engaging portion 22 is a bore adapted to receive the end of the tube element 12b in a friction fit arrangement. The second engaging portion 24 preferably comprises first 24a and second 24b concave portions sized and dimensioned to be positioned around a body portion 16 of the second tube element 12b, as shown in FIG. 6. According to the preferred embodiment, the first 24a and second 24b concave portions are formed from a semi-rigid material providing sufficient flexibility to allow a tube element to snap into place, or otherwise be easily positioned between the concave portions.

The terms intermediate portion 16 of the tube element and body portion of the tube element are used interchangeably in and throughout this description, and generally refer to any non-end portion of the tube element. In this manner, an end of a tube may be made to abut a body portion of another tube and thereby join two tubes at a particular angle. As shown in FIG. 6, tube 12c may, for example, be attached to tube 12a at an angle offset from vertical. The adaptor clamp 20 may be rotated until the desired angle is reached and then tightened, for example, by a bolt (not shown) extending through tightening hole 26. It will be understood by those skilled in the art that the particular shape and arrangement of adaptor clamp 20 as shown in FIG. 2 is merely a preferred embodiment. Other designs, orientations and adaptations that include the primary elements as herein described are within the scope of the present invention.

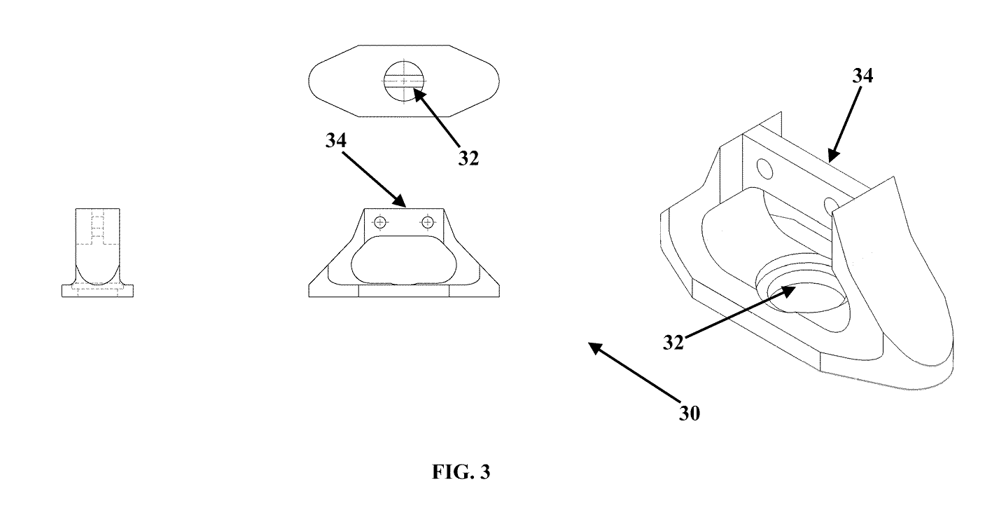

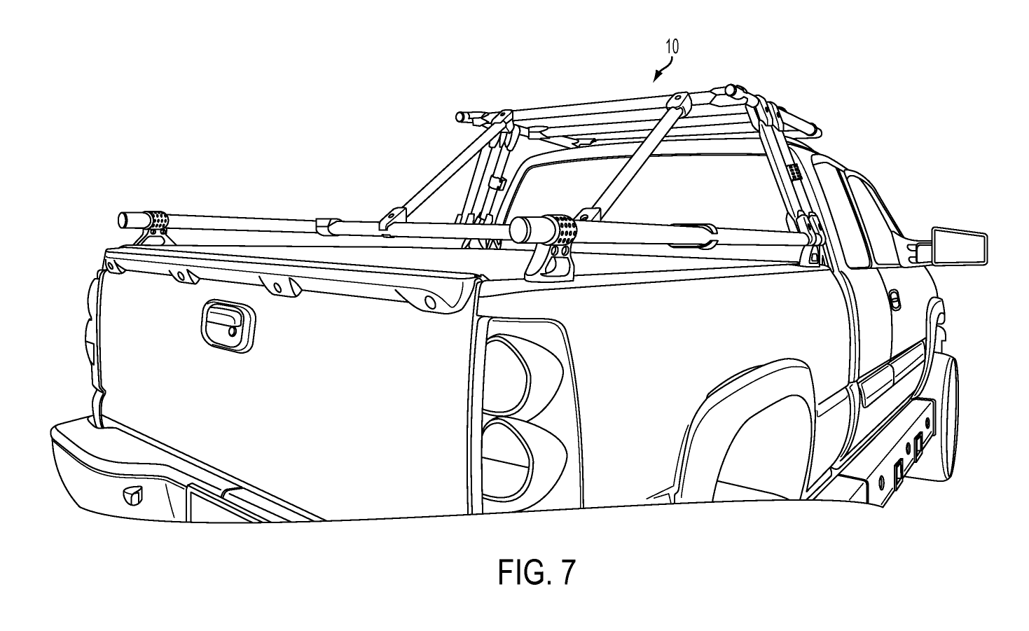

Referring now to FIGS. 3, 4 and 6, a representative base clamp is illustrated as having a first connector 40 for attaching a tubular member and a second connector 30, for attaching to the mounting surface via mounting means 32. The mounting surface may, for example, be the back of a pick-up truck, as shown in FIG. 7. Mounting means 32 may be any common hardware known to attach, mount, or otherwise support a mounting-bracket or similar device on a flat surface. Alternatively, the mounting means 32 may be designed to interact with features present on a pick-up truck, such as receiving holes within which to mount the base clamp 30 along with a bolt. The second connector may comprise a base portion, or mounting means 32, for attaching to the vehicle surface and a receiving portion 34 for engaging the connecting means of the first connector, as described below.

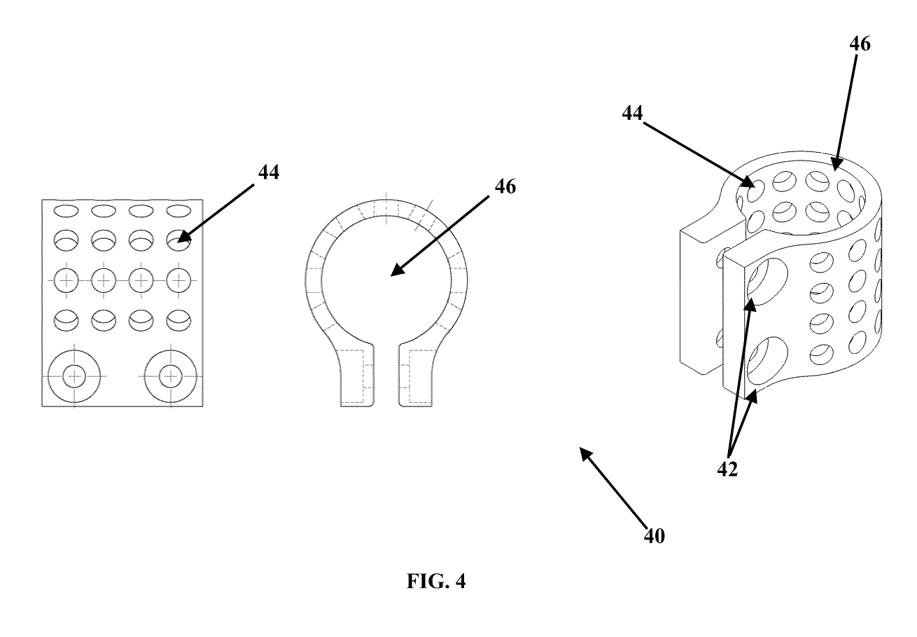

Referring now to FIGS. 4 and 6, an exemplary first connector 40 is shown. First connector 40 generally comprises a generally tubular receiving portion 46, sized and otherwise dimensioned to receive a section of tube 12a therein. The receiving portion is sized slightly larger than a diameter of the tube 12a such that it is easily assembled. Upon attachment of the second connector 40 to the first connector 30, bolts are provided to connect, and further tighten the adaptor clamp through bolt holes 42. Optionally, relief holes 44 are provided on a body of the adaptor clamp to reduce internal stresses upon tightening and otherwise allow for more flexibility in the adaptor clamp.

Alternatively, the base clamp may have a clamp portion unitary with a main body thereof, although more flexibility is provided with separate first and second connectors. For example, the first connector may be mounted onto a surface, the structure assembled at a nearby location, and then mounted and connected by attaching corresponding first connectors to the appropriate second connectors.

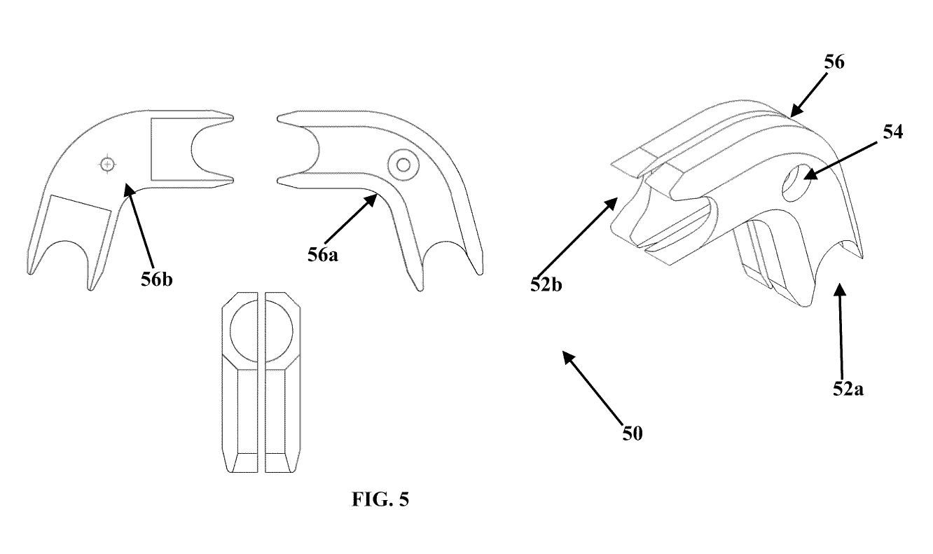

FIG. 5 shows another element that may optionally be included in the kit according to the present invention. Radius clamp 50 generally includes a curved body portion 56 having a tightening hole 54 therethrough, and first and second end portions 52a and 52b for receiving end portions of adjacent tube members. Optionally, the curved body portion 56 may be formed from cooperating body portion elements 56a and 56b, as shown. It will be understood by those skilled in the art that any number of radius clamps 50 having varying radii of curvature to the body portion 56 may be included in the kit of the present invention. Accordingly, tube elements may be assembled in any number of configurations when laid end-to-end, as would be particularly beneficial in forming base or roof-type portions to the structure. These could be particular helpful, for example, when forming racks or storage structures on ground level, and not mounted to the rear of a vehicle. For example, such storage structures may be formed for placement on the inside of a cargo truck, or shipping container in a manner that is not mounted directly onto the cargo truck, or shipping container, as the case may be. Other applications include the forming of framing for shelving or other carrier structures in stores or warehouses.

It will be understood by those skilled in the art that the tube elements 12 are preferably shelf-items that may be purchased at a typical hardware store. This way, an end user would use the individual clamps of the present invention, or the kit provided containing a number of each clamps, in combination with an appropriate number of tube elements to form storage, or other type of modular structures. Furthermore, alterations, additions, or expansions to the formed structure may easily be implemented by acquiring additional tubes and elements for the kit. This would also be particularly beneficial in forming cargo racks for storing different types and sizes of cargo.

Furthermore, any number of clamps as described above may be included with the kit according to the present invention. According to another aspect of the present invention, a system for constructing a rack on a vehicle and method of doing same in accordance with the description above is provided. The assembly of a rack from the kit herein described may be shaped, oriented and otherwise dimensioned such that a portion of the rack extends over a cab portion of the pick-up truck (not shown), and a portion extends downwards towards a base portion, thereby maximizing the space provided by the cargo rack.

According to other embodiments of the present invention, the elements of the kit as exemplified in FIGS. 2 to 5 in combination with appropriate tube members, may be used to form temporary out-door storage structures, by, for example, including a tarp, or other similar member, over the top of a formed structure.

The present invention also relates to a method for constructing a rack on a vehicle that includes providing standard off-the-shelf tube elements, providing a kit and/or clamps in accordance with the present invention, and forming a structure, such as a cargo rack as herein described, or otherwise, as would be appreciated by those skilled in the art.

The clamps of the present invention are preferably machined, die cast, extruded, or otherwise produced from aluminum, but other materials as would be known to those skilled in the art are also within the scope of the present invention.

Various other modifications and alterations may be used in the design and manufacture of the clamps and kit according to the present invention without departing from the spirit and scope of the invention. For example, the clamps may have different shaped body portions or engaging and end portions performing a similar function as herein described. Alternatively, other materials may be used as would be understood by those skilled in the art. Furthermore, where tubes of different cross-sections are provided, the clamps may be adapted to engage such.

Additionally, connector pieces or specific adaptor components may be provided to attach lights, radio antennas, road signs, construction signs, advertising, and spare tire carriers, and other mounting devices for connecting additional components to the structure. Furthermore, specific carrying functionality may be provided, for example, for transporting canoes, bicycles, off road vehicles, and other recreational devices that are often transported on out surfaces of cars or vans. The structure may also be used to create a protective system formed around windows of a truck. It will be understood by those skilled in the art that these applications are provided by way of example only and other uses for the modular structure are also contemplated by the present invention.

1. A kit for forming a modular rack for a vehicle comprising:
a plurality of adaptor clamps for connecting an end of any one of a plurality of tube elements to a body portion of another one of said plurality of tube elements;
a plurality of base clamps for connecting a portion of any one of the plurality of tube elements to a support surface on said vehicle.

2. A kit according to claim 1, wherein said plurality of tube elements are provided as part of the kit.

3. A kit according to claim 1, wherein said plurality of tube elements are tubes arranged to be cut to various sizes for use with said plurality of adaptor clamps and said plurality of base clamps.

4. A kit according to claim 1, wherein each of said plurality of adaptor clamps comprises a first engaging portion for engaging an end of a first tube element and a second engaging portion for engaging a body portion of a second tube element.

5. A kit according to claim 4, wherein said first engaging portion comprises a bore in a body portion of said adaptor clamp, sized and otherwise dimensioned to be secured to said end of said first tube element.

6. A kit according to claim 5, wherein said end of said first tube element is secured within said bore in a friction fit arrangement.

7. A kit according to claim 4, wherein said second engaging portion comprises first and second concave portions sized and dimensioned to be positioned around said body portion of said second tube element.

8. A kit according to claim 7, wherein said first and second concave portions are formed from a semi-rigid material; said second engaging portion further comprising fastening means for securing said tube element between said first and second concave portions.

9. A kit according to claim 1, wherein each of said plurality of base clamps comprises a first connector for attaching to a tube element and a second connector for attaching to said support surface on the vehicle.

10. A kit according to claim 9, wherein said first connector comprises a tube element support portion and connecting means for attachment to said second connector.

11. A kit according to claim 9, wherein said second connector comprises a base portion for attaching to the vehicle surface and an interacting portion for engaging said connecting means of said first connector.

12. A kit according to claim 1, further comprising a radius clamp having first and second ends adapted for engaging first and second proximate tube elements.

13. A system for constructing a rack on a vehicle comprising:
a plurality of adaptor clamps;
a plurality of base clamps; and
a plurality of tube elements;
wherein said plurality of tube elements are arranged to form the rack in a construction determined by a user, by connecting tube elements with each other with one or more of said plurality of adaptor clamps and by connecting base tube elements to the vehicle using one or more of said plurality of base clamps.

14. A system according to claim 13, wherein each said of said plurality of adaptor clamps comprises a first engaging portion for engaging an end of a first tube element and a second engaging portion for engaging a body portion of a second tube element.

15. A system according to claim 14, wherein said first engaging portion comprises a bore in a body portion of said adaptor clamp, sized and otherwise dimensioned to be secured to said end of said first tube element.

16. A system according to claim 15, wherein said end of said first tube element is secured within said bore in a friction fit arrangement.

17. A system according to claim 14, wherein said second engaging portion comprises first and second concave portions sized and dimensioned to be positioned around said body portion of said second tube element.

18. A system according to claim 17, wherein said first and second concave portions are formed from a semi-rigid material; said second engaging portion further comprising fastening means for securing said tube element between said first and second concave portions.

19. A system according to claim 13, wherein each of said plurality of base clamps comprises a first connector for attaching to a tube element and a second connector for attaching to said support surface on the vehicle.

20. A system according to claim 19, wherein said first connector comprises a tube element support portion and connecting means for attachment to said second connector.

21. A system according to claim 19, wherein said second connector comprises a base portion for attaching to the vehicle surface and an interacting portion for engaging said connecting means of said first connector.

22. A system according to claim 13, further comprising a radius clamp having first and second ends adapted for engaging first and second proximate tube elements.

23. A method for constructing a rack on a vehicle comprising:
providing a plurality of adaptor clamps;
providing a plurality of base clamps;
providing a plurality of tube elements;
connecting ends of said plurality of tube elements to a body portion of another one of said plurality of tube elements using said plurality of adaptor clamps to form the rack; and
connecting a portion of any one of the plurality of tube elements to a support surface on said vehicle using said plurality of base clamps.
